(19) United States
(12) Patent Application Publication
(10) Pub. No.: US 2020/0263305 A1
(43) Pub. Date: Aug. 20, 2020

(54) BLACKENED ROD WITH ANTICORROSIVE COATING

(71) Applicants: John C. GRAY, Dayton, OH (US); Thomas L. RATERMAN, Minster, OH (US)

(72) Inventors: John C. GRAY, Dayton, OH (US); Thomas L. RATERMAN, Minster, OH (US)

(73) Assignee: L & H Threaded Rods Corp., Dayton, OH (US)

(21) Appl. No.: 16/791,266

(22) Filed: Feb. 14, 2020

Related U.S. Application Data
(60) Provisional application No. 62/805,378, filed on Feb. 14, 2019.

(51) Int. Cl. C23C 22/50; F16L 25/04; C09D 5/08; C23C 22/78

(52) U.S. Cl. CPC C23C 22/50; C23C 22/78; C09D 5/082; F16L 25/04

(57) ABSTRACT

A system including a rod shaped and configured to be formed into a U-bolt, the rod including a body having a pair of opposed threaded ends. The system further includes a blackening coating on an outer surface of the body, and an anticorrosive coating on the blackening coating.

This application claims priority to U.S. Provisional Patent Application Ser. No. 62/805,378, filed on Feb. 14, 2019, the entire contents of which are hereby incorporated by reference.

### FIELD

This disclosure is directed to a U-bolt and to a metal rod useful in forming a U-bolt. This disclosure is also directed to a method for producing a metal rod and/or U-bolt having an anticorrosive coating.

### BACKGROUND

U-bolts are used in a wide range of applications. In the automotive industry, U-bolts can be used to securing truck and trailer suspensions, springs, and for other uses. U-bolts are typically available in a range of sizes and in a variety of steels and finishes. Suppliers such as L & H Threaded Rods Corporation provide unbent threaded rods in various lengths and diameters which purchasers can bend around a die of a bending machine to form a U-bolt. For example, L & H currently sells rods in diameters ranging from ⅜ inch to 1¼ inch in ⅛ inch increments, and in lengths ranging from 10 inch to 48 inch in 2 inch increments.

U-bolt manufacturers usually place the unbent rods in a supply rack where they are sorted by length and diameter. One problem can occur when the rods are misplaced in the supply rack and the wrong length rod is selected for bending. Another problem can occur because the rods are often coated with a thin coating of an oil to prevent corrosion, or oil can drip on the rods during manufacture or storage. When the rods are removed from the storage rack and positioned on the bending machine, the oil can rub off on the hands and gloves of the worker. Oil on the rods can also taint the container in which the rods are stored or shipped. For example, if the container is made of packaging board, the oil can weaken the packaging board and enable it to tear prematurely. In addition, existing rods may not be sufficiently corrosion-resistant.

### SUMMARY

In one embodiment, the invention is a system including a rod shaped and configured to be formed into a U-bolt, the rod including a body having a pair of opposed threaded ends. The system further includes a blackening coating on an outer surface of the body, and an anticorrosive coating on the blackening coating.

### BRIEF DESCRIPTION OF THE DRAWINGS

FIG. 1 illustrates one embodiment of a threaded rod;

FIG. 2 illustrates the rod of FIG. 1, bent into a U-bolt;

FIG. 3 is a schematic illustration of the rod of FIG. 2 installed on a part of a vehicle;

FIG. 4 is a schematic diagram illustrating one method for producing a metal rod; and

FIG. 5 is an illustration of a color coding system for identifying the length of a rod.

### DETAILED DESCRIPTION

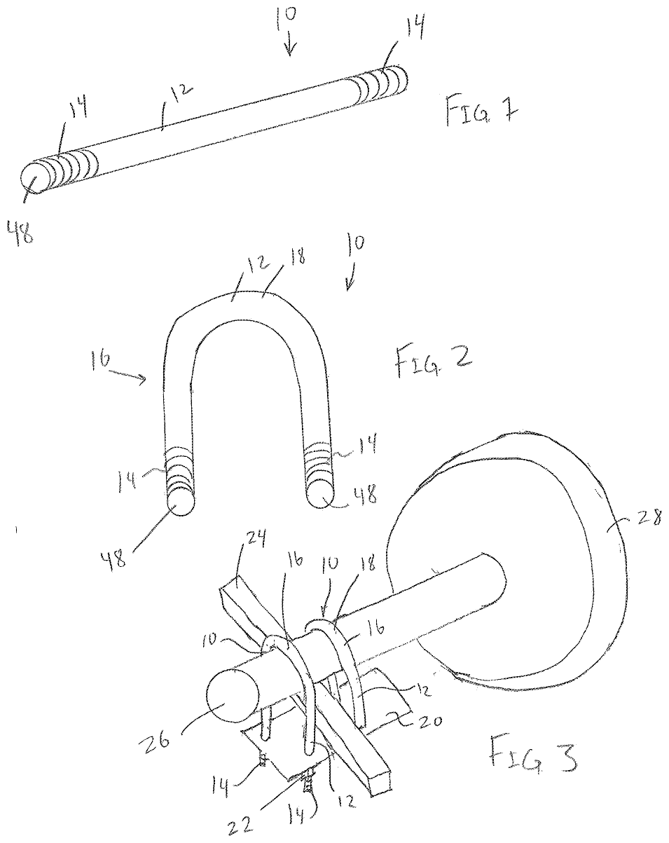

As shown in FIG. 1, the rod 10 shown therein can include a generally cylindrical body 12 and a pair of threaded ends 14. The rod 10/body 12 can have a circular cross section, although portions of the rod 10/body 12 away from the ends 14 thereof can have various other cross sections if desired, for example, square or the like. In one embodiment each threaded end 14 extends at least about 10%, or in another case at least about 25%, and in another case less than about 30%, of the length of the rod 10/body 12.

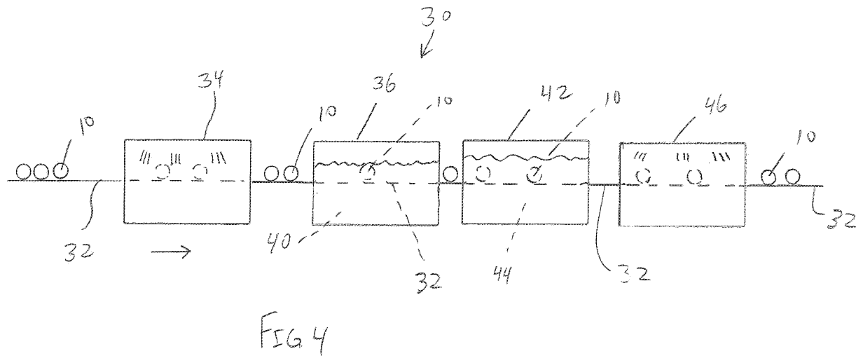

As shown in FIG. 2, the rod 10/body 12 can be bent into a U-bolt 16, with parallel threaded ends 14, by any of a wide variety of known bending techniques, including by bending the rod 10/body 12 around a die at a point at the center of the rod 10/body 12 equidistant from each end. The base 18 of the U-bolt 16 can be rounded, semi-rounded, square or generally square, and in all such cases the resulting structure is nevertheless termed a U-bolt 16. Moreover the U-shape structure 16 shown in FIG. 2 can also be termed or considered a rod 10, simply one that is in a U-shape rather than being straight.

The rod 10/body 12 can be made of metal or other ferrous materials, including low carbon steels, medium carbon steels or high carbon steels. Any rod 10/body 12 used in forming a U-bolts 16 by bending around a U-bolt die can be useful in practicing this disclosure. Appropriate rods 10 are commercially available from L&H Threaded Rods Corp. of Moraine, Ohio, and include high quality medium carbon 1541 Grade 5, high carbon Grade 8 and lower carbon 1018's, 1020's and 1040's.

The U-bolt 16 can be used in various applications, including in one case by attaching components to the undercarriage of an automobile chassis or frame, or other components. In the embodiment of FIG. 3, the two U-bolts 16 are passed through a plate 20 and secured by nuts 22 threaded onto the threaded end 14 (only one nut 22 is visible in FIG. 3) threaded onto the threaded ends 14. In the embodiment of FIG. 3 the U-bolts 16 secure a schematically-illustrated leaf spring 24 to an axle 26 of an automobile, which is in turn coupled to a wheel 28. However, it should be understood that the U-bolt 16 can be used in any of a wide variety of applications beyond that shown in FIG. 3.

The rod 10 of FIG. 1 may, prior to or after being formed into the U-bolt 16, be treated to improve its corrosion resistance, including by cold blackening. In one case, as a first step in the treatment process the rod 10 is shot blasted with metal particles and/or sand blasted to remove scale and any other debris, and to prepare the rod 10 for further treatment. The rod 10 is then thoroughly cleaned to remove any contaminants, such as drawing and manufacturing oils, cutting debris and the like. If the rod 10 is not well cleaned at this stage, after blackening the blackened surface of the rod 10 may be non-uniform and/or mottled.

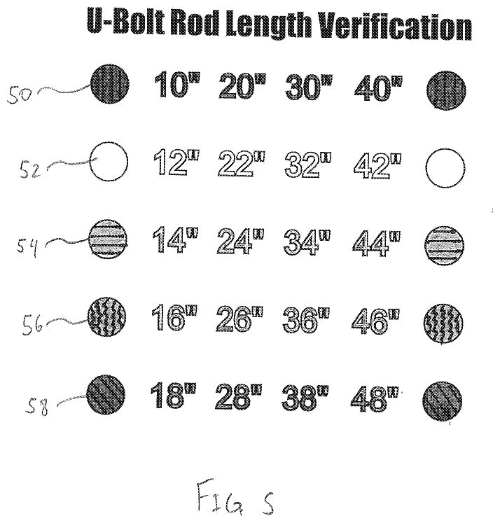

One example of a process for treating the rod 10/U-bolt 16 is shown schematically in FIG. 4 where the manufacturing line is generally indicated by the numeral 30. The rods 10 are transported along the line on a conveyor 32. The conveyor 32 carries the rods 10 to a first treatment station 34 where the rods 10 are prepared for blackening by treating the rods 10 with a cleaner, as outlined above, such as by spraying the rods 10 with the cleaning solution, dipping the rods 10 in the cleaning solution or the like. One example of such a cleaning solution used at the first treatment station 34 is an alkaline (pH about 10-11) cleaning solution. However, acid solutions can also be used.

From the first treatment station 34 the rods 10 are transported, such as by being carried on the conveyor 32, to and through a blackening station 36 including in one case a vat of a blackening solution 40. The conveyor 32 can be positioned in or extend through the vat of blackening solution 40 so that the rods 10 are, in one case, immersed in the blackening solution 40 as they travel through the vat. The vat and conveyor 32 can be designed and operated so that the rods 10 are exposed to the blackening solution 40 for sufficient time (e.g. at least one minute in one case, and less than ten minutes in another case) that the rods 10 are adequately blackened as they travel through the blackening station 36. The solution of the blackening agent 40 may be a black oxide former such as a solution including copper sulphate and selenious acid. One example of a copper selenide solution is described below, but blackening agents than copper selenide can be used.

One specific example of a cold black oxide former that can be used for blackening contains about 60-70% water, about 10-15% selenious acid, about 3-6% copper (II) sulfate penthydrate, about 4-8% phosphoric acid, and about 3-6% nitric acid. This solution can be used or applied at approximately ambient temperature, e.g., between about 60° F. and about 100° F. In one process, the black oxide coating is obtained by immersing the rod 10 in the blackening solution for about 1-5 minutes. Additional treatment for blackening is generally not required. The black oxide coating can be applied/formed without materially affecting the diameter or thickness of the rod 10, as the coating can have a thickness than is less than about 2 microns, and does not adversely affect the ability of the threaded ends 14 to accept a threaded nut 22. The black oxide coating, and the chemicals associated with such treatment, can convert a surface layer of the rod 10 to and/or form coating of a formed/deposited copper selenium compound such as but not limited to copper selenide or CuSe or Cu₂Se.

As an alternative to applying the cold black oxide coating described above, it also within the scope of this disclosure to have the black oxide coatings applied/formed by hot oxide processes, instead of cold forming. However, hot black oxide processes may be less desirable in this application due to the heat involved and the nature of the reagents used. After the hot blackening process is complete, a magnetite (Fe₃O₄) coating is formed on the outer surface of the rod 10.

From the blackening station 36, the rods 10 are carried to a rinse station 42 which contains a vat of a rinse solution 44, such as water or an aqueous solution, in which the rods 10 are immersed as they travel through the station 42. The rinse solution 44 stops the blackening process. After the rods 10 have been blackened and rinsed as described above, the rods 10 can be transported on the conveyor 32 to a station 46 where they are coated with an anticorrosive sealant or coating. The blackening process/coating provides a porous or textured surface on the rod 10 that is particularly suitable for securely bonding the anticorrosive coating to the rod 10, but does not adversely affect the ability of threaded ends 14 to accept a threaded nut 22. The porous crystalline structure of the black finish of the rods 10 makes it an excellent absorbent base for an anticorrosive coating. Corrosion resistance can be accomplished using a variety of anticorrosive coatings provided the coatings bind to the black oxide coating as described herein. In one particular embodiment the anticorrosive coating is an acrylic polymer or an acrylic lacquer that is applied to the black oxide surface and then dried. After drying the rod 10 can present a continuous black surface about all outer/exposed surfaces that is dry to the touch. The anticorrosive coating may be generally clear or transparent, or sufficiently translucent, particular when applied as a film, that the rods 10 appear black even after application of the anticorrosive coating. After the rods 10 are formed, a label that identifies the diameter and/or length of the rod 10 can be coupled to the rod 10.

In combination, the blackened outer surface of the rods 10 and the anticorrosive coating provide the rod 10 with a strong dry, non-oily and non-tacky barrier to corrosion. Without blackening the rod 10, the anticorrosive layer would be prone to be removed or scratched off of the rod 10 during bending or installation of the U-bolt, or in use in the field. On the blackened surface, the anticorrosive coating imparts anticorrosive properties and a dry touch to the rod 10 thereby making the rod 10 more convenient to handle and more industrially and commercially desirable. In addition, the undercarriage of many automobiles is of a black color. By providing rods 10 that are of a black color, and also corrosive resistant, the rods 10/U-bolts 16 can naturally blend in with the rest of the components on the undercarriage of an automobile.

While the process has been illustrated in FIG. 4 by immersing the rods 10 in successive vats of liquids/solutions/reagents, the process is not limited to immersing the rods 10 but could also be carried out using spray applications or a combination of spray and immersion treatments. Moreover, any steps shown as spraying may be able to be accomplished by immersion.

After the rods 10/U-bolt 14 are formed, they can have patches of color applied thereto, such an on the (circular, axial) ends 48 of the threaded ends 14. The color coding can provide useful information to a user as to the length of the rod 10 which can have various discrete lengths. The chart of FIG. 5 provides one example of how code colors can be used to mark the ends of the rods 10 in accordance with a more specific aspect of this disclosure. In one example, the right and left columns of FIG. 5 are circles showing the colors red 50, white 52, blue 54, gold 56 and green 58 from top to bottom on each side of the figure. In this illustration, rod ends 48 that are colored red designate or are indicative of rods 10 that are 10, 20, 30 or 40 inches long; rod ends 48 that are white indicate rods that are 12, 22, 32, or 42 inches long; rod ends 48 that are blue indicate rods that are 14, 24, 34, or 44 inches long; rod ends 48 that are gold indicate rods that are 16, 26, 36, or 46 inches long; and rod ends 48 that are green indicate rods that are 18, 28, 38 or 48 inches long. The color markings may be unique such that each rod of the same length is marked with the associated color, and only that color, on the axial ends 48. While more code colors could be used, in practice it has been found that a user can readily distinguish by eye between the four lengths of rods 10, each of which can be marked by the same color, since each rod marked by the same color differ by ten inches in length. This makes the use of additional code colors unnecessary.

Thus in one embodiment the color coding system can use different colors on the ends 48 of the rods 10 to designate rods 10 having differing lengths where the rods 10 differ in length by at least ten inches, or some other predetermined number as desired. In one case the predetermined number is six inches in one case, eight inches in another case, or twelve inches in another case, and in another case is the length of the shortest rod 10 of the set of rods 10 marked according to the color marking scheme. In yet another case the predetermined number is 25% of the longest rod 10 of the set of rods 10 marked according to the color marking scheme. In other words, repeating identifying colors can be used, so long as the rods 10 have a sufficiently different length.

In one embodiment the color coding system can use the same colors on the ends 48 of the rods 10 to designate rods having differing lengths where the rods 10 differ in length by at least ten inches, or some other predetermined number as desired as outlined above. Thus the same color can be used to indicate rod lengths that differ by at least ten inches in one case, or other lengths as desired. Although the number of colors used can vary, and the number is five in the illustrated embodiment, in another case the number of differing colors can be at least three. The color identifying scheme can also or instead be used to identify other parameters of the rods 10, such as diameter, material, coating, etc.

Having described the invention in detail and by reference to specific or preferred embodiments thereof, it will be apparent that modifications and variations are possible without departing from the scope of the invention which is defined in the appended claims.

What is claimed is:

1. A system including a rod shaped and configured to be formed into a U-bolt comprising:
a body having a pair of opposed threaded ends;
a blackening coating on an outer surface of the body; and
an anticorrosive coating on the blackening coating.

2. The system of claim 1 wherein the blackening coating is a cold blackening coating in the form of a copper selenium compound.

3. The system of claim 1 wherein the blackening coating is a cold blackening coating formed by immersing the body in an aqueous solution of copper salt and selenious acid.

4. The system of claim 1 wherein the blackening coating is a cold blackening coating formed by immersing the body in a solution of about 60-70% water, about 10-15% selenious acid, about 3-6% copper (II) sulfate penthydrate, about 4-8% phosphoric acid, and about 3-6% nitric acid.

5. The system of claim 1 wherein the anticorrosive coating is an acrylic polymer.

6. The system of claim 1 wherein the body is ferrous metal.

7. The system of claim 1 wherein the body is straight along its entire length.

8. The system of claim 1 wherein the body is in a U-bolt shape.

9. The system of claim 1 wherein the axial ends of the body are marked with a color indicative of a length the body.

10. The system of claim 9 comprising a plurality of rods of various discrete lengths, wherein each rod is marked with the same color as other rods having the same length, and wherein no rods are marked with colors different from other rods having the same length, and wherein each rod having a first length is marked with the same color of another rod having a second length, and wherein first length and the second length differ by ten inches.

11. The system of claim 9 comprising a plurality of rods of various discrete lengths, wherein a first set of rods all have the same length and are marked with a first color, wherein a second set of rods all have the same length and are marked with a second color, a third set of rods all have the same length and are marked with a third color, a fourth set of rods all have the same length and are marked with the first color and are at least six inches longer than the first set of rods, a fifth set of rods all have the same length and are marked with the second color and are at least six inches longer than the second set of rods, and a sixth set of rods all have the same length and are marked with the third color and are at least six inches longer than the third set of rods.

12. The system of claim 1 wherein the body is coupled to an undercarriage of an automobile.

13. A method for treating a rod comprising:
immersing a ferrous rod in a solution of a blackening agent to form a blackened surface on the rod;
removing the rod from the solution of the blackening agent; and
applying an anticorrosive coating to the blackened surface of the rod.

14. The method of claim 13 wherein the blackening agent is a cold black oxide forming solution.

15. The method of claim 13 wherein the blackening agent is a solution including copper sulfate and selenious acid.

16. The method of claim 13 wherein the anticorrosive coating is an acrylic polymer.

17. The method of claim 13 further comprising bending the rod into a U-bolt shape after the applying step.

18. The method of claim 17 further comprising attaching the rod, after it is bent into the U-bolt shape, to an undercarriage of an automobile.
